(19) United States
(12) Patent Application Publication
(10) Pub. No.: US 2024/0359422 A1
(43) Pub. Date: Oct. 31, 2024

(54) PE PRODUCTS FOR TEXTILE AND METHOD FOR MANUFACTURING SAME

(71) Applicant: YiLab Temperature Control Technologies ( Changzhou ) Co., Ltd., Shanghai (CN)

(72) Inventors: Cindy Yee Cin LAU, Palo Alto, CA (US); John Joseph Collier, Sunnyvale, CA (US); Oscar Lee, Sunnyvale, CA (US); Raymond Scott Mellin, Sunnyvale, CA (US); Nicole Kenney, Sunnyvale, CA (US); Rachel Chin, Sunnyvale, CA (US); Pei Zhu, Santa Clara, CA (US); Vijanderan Somasundaram, Sunnyvale, CA (US)

(21) Appl. No.: 18/767,260

(22) Filed: Jul. 9, 2024

Related U.S. Application Data
(63) Continuation of application No. PCT/US2023/010926, filed on Jan. 17, 2023.
(60) Provisional application No. 63/299,679, filed on Jan. 14, 2022.
(60) Provisional application No. 63/305,826, filed on Feb. 2, 2022.

(51) Int. Cl. B32B 5/26; B32B 7/09; B32B 7/12; B32B 27/12; B32B 27/16; B32B 37/04

(52) U.S. Cl. CPC B32B 5/26; B32B 7/09; B32B 7/12; B32B 27/12; B32B 27/16; B32B 37/04; B32B 2255/10; B32B 2255/205; B32B 2262/0253; B32B 2262/0276; B32B 2307/304

(57) ABSTRACT

A textile includes a first piece of fabric consisting of polyethylene (PE) and a second piece of fabric consisting of PE. The first piece of fabric and the second piece of fabric are connected by a medium consisting of PE.

### CROSS REFERENCE TO RELATED APPLICATION

This application is a continuation application of International Application No. PCT/US2023/010926, filed on Jan. 17, 2023, which claims priority to U.S. Provisional Application No. 63/299,679 filed Jan. 14, 2022 and U.S. Provisional Application No. 63/305,826 filed Feb. 2, 2022. The contents of all of the above-identified applications are incorporated herein by reference in their entirety.

### TECHNICAL FIELD

This disclosure is generally related to textile for apparels, footwears, tents, sleeping bags, beddings, and automobile, and household applications, and more specifically to full polyethylene textiles for apparels, footwears, tents, sleeping bags, beddings, and automobile and household applications, and methods for fabricating same, and to a textile having an infrared transparent insulation layer.

### BACKGROUND

According to article (https://www.bbc.com/future/article/20200710-why-clothes-are-so-hard-to-recycle), around 85% of all textiles thrown away in the US—roughly 13 million tons in 2017—are either dumped into landfill or burned. The average American has been estimated to throw away around 37 kg of clothes every year. And globally, an estimated 92 million tons of textiles waste is created each year and the equivalent to a rubbish truck full of clothes ends up on landfill sites every second. By 2030, we are expected as a whole to be discarding more than 134 million tons of textiles a year.

One of the challenges of recycling garment is the multiple materials used within them.

### SUMMARY

In one aspect, described herein are textiles for use in apparels, footwears and beddings that are comfortable to wear and/or use and made of 100% polyethylene (PE).

In one embodiment, a textile is provided. The textile includes a first piece of fabric consisting of polyethylene (PE) and a second piece of fabric consisting of PE. The first piece of fabric and the second piece of fabric are connected by a medium consisting of PE.

In some embodiments, the medium connecting the first piece of fabric and the second piece of fabric is a PE sewing thread. For example, the PE sewing thread is 300 denier and has a tenacity of 3.93 cN/dtex and elongation of 15%. In some embodiments, the PE sewing thread is 150 denier and has a tenacity of 2.0 cN/dtex and elongation of 32%.

In some embodiments, the medium connecting the first piece of fabric and the second piece of fabric is a PE adhesive.

In some embodiments, the medium connecting the first piece of fabric and the second piece of fabric is a melt of the first piece of fabric and the second piece of fabric. In some embodiments, the melt of the first piece of fabric and the second piece of fabric is produced by performing an ultrasonic welding, an infrared welding, or an induction welding on the first piece of fabric and the second piece of fabric.

In some embodiments, the first piece of fabric is consisted of one or more first PE yarns.

In some embodiments, the second piece of fabric is consisted of one or more second PE yarns.

In some embodiments, the medium is a PE adhesive, and a melting temperature of the PE adhesive is lower than a melting temperature of the one or more first PE yarns or a melting temperature of the one or more second PE yarns.

In another aspect, described herein are textiles having an infrared (IR) transparent insulation layer for apparels, footwears, tents, sleeping bags, beddings, and automobile, and household applications.

In one embodiment, a textile product is provided. The textile product includes a metallized sheet and an insulation layer disposed on the metallized sheet. The insulation layer includes a fibrous insulation and has an IR transmittance of at least 20% at a wavelength of 9.5 μm.

In some embodiments, the insulation layer has an IR transmittance of at least 25% at a wavelength of 9.5 μm. In some embodiments, the insulation layer has an IR transmittance of at least 30% at a wavelength of 9.5 μm. In some embodiments, the insulation layer has an IR transmittance of at least 35% at a wavelength of 9.5 μm. In some embodiments, the insulation layer has an IR transmittance of at least 40% at a wavelength of 9.5 μm. In some embodiments, the insulation layer has an IR transmittance of at least 50% at a wavelength of 9.5 μm. In some embodiments, the insulation layer has an IR transmittance of at least 70% at a wavelength of 9.5 μm. In some embodiments, the insulation layer has an IR transmittance of at least 90% at a wavelength of 9.5 μm.

In some embodiments, the fibrous insulation of the insulation layer comprises fibers of one or more of polyethylene, polypropylene, and nylon. In some embodiments, the fibrous insulation of the insulation layer consists of polyethylene fibers.

In some embodiments, the fibrous insulation of the insulation layer further comprises polyester.

In some embodiments, the metallized sheet includes a base layer containing a polymer and a metal layer deposited on the base layer.

In some embodiments, the textile product further includes a polyethylene adhesive disposed between the metallized sheet and the insulation layer.

In another aspect, a textile product is provided. The textile product includes a metallized sheet, an insulation layer disposed on the metallized sheet, and a cover layer disposed on the insulation layer. The insulation layer includes a fibrous insulation and has an IR transmittance of at least 20% at a wavelength of 9.5 μm.

In some embodiments, the textile product is included one of an apparel, a footwear, a tent, a sleeping bag, bedding, automobile, and other household products.

In some embodiments, the textile is included one of an apparel, a footwears, a tent, a sleeping bag or bedding.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 is a schematic diagram depicting a textile joint according to one example embodiment.

FIG. 2 is a flow chart illustrating a method for manufacturing a full PE textile product, according to one example embodiment.

FIG. 3 is a flow chart illustrating another method for manufacturing a full PE textile product, according to one example embodiment.

FIG. 4 is a flow chart illustrating yet another method for manufacturing a full PE textile product, according to one example embodiment.

FIG. 5 is a schematic diagram depicting a textile according to one example embodiment.

FIG. 6 is a schematic diagram depicting another textile according to one example embodiment.

FIG. 7 is a schematic diagram depicting a metallized sheet according to one example embodiment.

FIG. 8 is a schematic diagram depicting another metallized sheet according to one example embodiment.

FIG. 9 is a schematic diagram depicting yet another metallized sheet according to one example embodiment.

FIG. 10 is a schematic diagram depicting yet another metallized sheet according to one example embodiment.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to textiles that are recyclable. Various techniques disclosed herein are provided to produce a full PE textile.

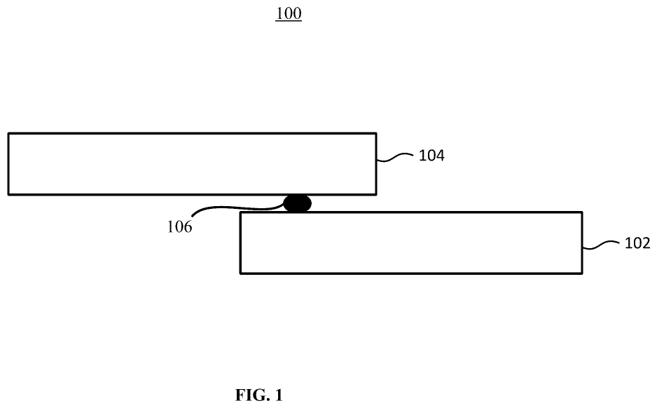

Embodiments will now be explained with accompanying figures. Reference is first made to FIG. 1. FIG. 1 is a schematic diagram depicting a textile 100 according to one example embodiment. The textile 100 includes first piece of fabric 102 consisting of PE and a second piece of fabric 104 consisting of PE. The first piece of fabric 102 and the second piece of fabric 104 are connected by a medium 106 consisting of PE.

The full PE textile can provide instant cooling feel suitable for personal cooling products. Each of the first piece of fabric 102 and the second piece of fabric 104 may be formed by PE yarns that include one or more PE filaments. Each of the first piece of fabric 102 and the second piece of fabric 104 may be formed with PE yarns with weaving, knitting and/or non-woven methods. In some embodiments, each of the first piece of fabric 102 and the second piece of fabric 104 can have a cool touch/feel with a Qmax value of at least 0.14 W/cm². To provide even better cooling feel, each of the first piece of fabric 102 and the second piece of fabric 104 is configured has a Qmax value of at least 0.14, 0.15, 0.16, 0.17, 0.18, 0.19, 0.20, 0.22, 0.24, 0.26, 0.28, 0.30, 0.35, 0.40, or 0.45 W/cm², or between any two of the above values. In some embodiments, the filaments have an average diameter of less than 20 μm, less than 25 μm, less than 30 μm, less than 35 μm, less than 40 μm, less than 45 μm, less than 50 μm, or between any two of the above numbers.

In some embodiments, dyestuff can be included in the yarns to provide a desired color for the yarns and eventually for the first piece of fabric 102 and/or the second piece of fabric 104. In some embodiments, the yarns can also include ultraviolet block agent, such as TiO₂ and/or ZnO.

In some embodiments, a 300 denier PE yarn has a tenacity of 2.53 cN/dtex and elongation of 137%. In some embodiments, another 300 denier PE yarn has a tenacity of 1.70 cN/dtex and elongation of 77%. In some embodiments, a 150 denier PE yarn has a tenacity of 2.15 cN/dtex and elongation of 94%. Another 150 denier PE yarn has a tenacity of 2.20 cN/dtex and elongation of 150%. Property of these example yarns is summarized in Table I below.

TABLE I

| | Tenacity | Elongation | Boiling water |
|---|---|---|---|
| Yarns | (cN/dtex) | (%) | shrinkage (%) |
| PE yarn 300d (I) | 2.53 | 137 | 14 |
| PE yarn 300d (II) | 1.70 | 77 | 8 |
| PE yarn 150d (I) | 2.15 | 94 | 12 |
| PE yarn 150d (II) | 2.20 | 150 | 14 |

In some embodiments, the medium 106 connecting the first piece of fabric 102 and the second piece of fabric 104 is a PE sewing thread. For example, the PE sewing thread is 300 denier with a tenacity of 3.93 cN/dtex and elongation of 15%. In one embodiment, the PE sewing thread is 150 denier and has a tenacity of 2.0 cN/dtex and elongation of 32%. Property of these example PE sewing threads is summarized in Table II below.

TABLE II

| | Tenacity | Elongation | Boiling water |
|---|---|---|---|
| Yarns | (cN/dtex) | (%) | shrinkage (%) |
| PE sewing thread 300d | 3.93 | 15 | 7 |
| PE sewing thread 150d | 2.0 | 32 | 10 |

The disclosed PE sewing threads have an improvement in strength (higher tenacity) and elongation (lower) over the conventional PE yarn for knitting/weaving. These improvements are achieved through an increase in twisting.

In some embodiments, the medium 106 connecting the first piece of fabric 102 and the second piece of fabric 104 is a PE adhesive. A melting temperature of the PE adhesive (e.g., about 116-123° C.) is lower than a melting temperature (e.g., about 130° C.) of the PE yarns that form the first piece of fabric 102 and/or the second piece of fabric 104. This ensures that when heating the PE adhesive to bond the first piece of fabric 102 and the second piece of fabric 104, the structural integrity of the first piece of fabric 102 and the second piece of fabric 104 to allow the appearance of the first piece of fabric 102 and the second piece of fabric 104 to maintain in a good shape.

In some embodiments, the medium 106 connecting the first piece of fabric 102 and the second piece of fabric 104 is a melt of the first piece of fabric and the second piece of fabric. When this technique is applied, any additional material is eliminated in joining the seam(s) between the first piece of fabric 102 and the second piece of fabric 104. In some embodiments, the melt of the first piece of fabric and the second piece of fabric is produced by performing an ultrasonic welding, an infrared welding, or an induction welding on the first piece of fabric 102 and/or the second piece of fabric 104. In some embodiments, the welding techniques are performed such that the appearance of the first piece of fabric 102 and/or the second piece of fabric 104 remain unchanged while only one or both of the internal surfaces (i.e., the surfaces of the first piece of fabric 102 and/or the second piece of fabric 104 facing the medium 106) are melt to form the medium 106.

The medium 106 can be a continuous line or formed with disconnected portions with a uniform interval or random intervals. In some embodiments, to provide stronger connection strength, a plurality of the media 106 can be disposed between the first piece of fabric 102 and the second piece of fabric 104.

In some embodiments, the textile 100 is highly breathable. For example, the textile has a moisture vapor transmission rate (MVTR) of at least 800 g/m²/24 hr. For example, the cooling-feel composite textile 100 has a MVTR of 800, 900, 1000, 1200, 1400, 1600, 1800, 2000, 2200, 2400, 2500, 2600, 2800, 3000 g/m²/24 hr, or more, or between any two of the above numbers.

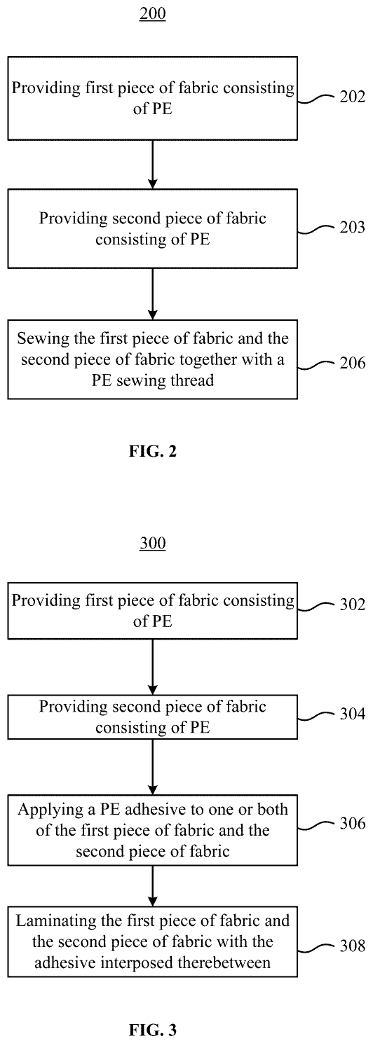

FIG. 2 is a flow chart illustrating a method 200 for manufacturing a full PE textile product, according to one example embodiment. At 202, a first piece of fabric consisting of PE is provided. The first piece of fabric can be made of one or more PE yarns. Each of the PE yarns are formed with one or more PE filaments. At 204, a second piece of fabric consisting of PE is provided. The second piece of fabric can be made of one or more PE yarns. Each of the PE yarns are formed with one or more PE filaments. At 206, the first piece of fabric and the second piece of fabric are sewed together with a PE sewing thread.

FIG. 3 is a flow chart illustrating a method 300 for manufacturing another full PE textile product, according to one example embodiment. At 302, a first piece of fabric consisting of PE is provided. The first piece of fabric can be made of one or more PE yarns. Each of the PE yarns are formed with one or more PE filaments. At 304, a second piece of fabric consisting of PE is provided. The second piece of fabric can be made of one or more PE yarns. Each of the PE yarns are formed with one or more PE filaments. At 306, a PE adhesive is applied to one or both of the first piece of fabric and the second piece of fabric. At 308, the first piece of fabric and the second piece of fabric are laminated one on top of the other such that the PE adhesive is interposed between the base layer and the membrane to bond them together. In this step, the PE adhesive is heated to a temperature above the melting point of the PE adhesive and below the melting point of the first piece of PE fabric and the second piece of PE fabric.

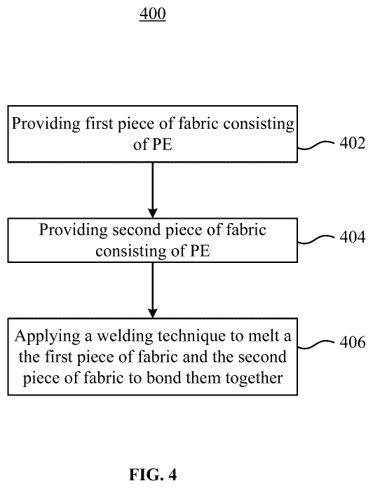

FIG. 4 is a flow chart illustrating a method 400 for manufacturing another full PE textile product, according to one example embodiment. At 402, a first piece of fabric consisting of PE is provided. The first piece of fabric can be made of one or more PE yarns. Each of the PE yarns are formed with one or more PE filaments. At 404, a second piece of fabric consisting of PE is provided. The second piece of fabric can be made of one or more PE yarns. Each of the PE yarns are formed with one or more PE filaments. At 406, a welding technique is applied to the first piece of PE fabric and/or the second piece of PE fabric to melt an internal surface of the first piece of PE fabric and/or the second piece of PE fabric to bond them together.

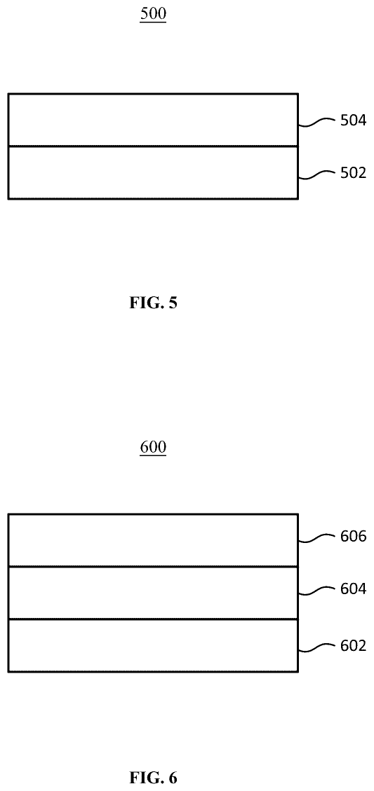

Reference is made to FIG. 5. FIG. 5 is a schematic diagram depicting a textile 500 according to one example embodiment. The textile 500 includes a metallized sheet 502 and an insulation layer 504 disposed on the metallized sheet. The insulation layer 504 includes a fibrous insulation and has an IR transmittance of at least 20% at a wavelength of 9.5 μm.

The textile 500 can be employed for warming purpose and be included in various applications, such as apparels, footwears, tents, sleeping bags, beddings, and automobile, and household applications, where the insulation layer 504 in intended to be placed close to human body. When the heat emitted from human body, it may be in the form of thermal radiation in the mid-infrared wavelengths, typically in the range of 7 to 14 μm with an peak wavelength at 9.5 μm. The thermal radiation first goes through the insulation layer 504 and then is reflected by the metallized sheet 502 back to the human body, thereby keeping the thermal energy close to the user. In this process, a portion of the thermal radiation is absorbed by the insulation layer 504 and would not be able to reach the metallized sheet 502 to complete the reflection. This reduces the purpose of providing warming feel to human body. The techniques disclosed herein provide an IR transparent insulation layer 504 to reduce IR absorption at the insulation layer 504 and improves the warming effects.

To provide IR transparency, the insulation layer 504 includes fibers made of one or more IR transparent materials. For example, the IR transparent materials may include polyethylene, polypropylene, and nylon. In some embodiments, the insulation layer 504 includes different fibers made of different materials. For example, the insulation layer 504 may include polyethylene fibers, polypropylene fibers, and/or nylon fibers. In some embodiments, in addition to IR transparent fibers, the insulation layer 504 may include non-IR transparent fibers to provide other desired properties to the insulation layer 504. For example, the insulation layer 504 may include polyester fibers to improve stability. In some embodiments, to provide highly IR transparency, the insulation layer 504 may consist of polyethylene fibers.

Depending on the ratio (weight or volume) of IR transparent fibers and non-IR transparent fibers, the insulation layer 504 may have an IR transmittance at a wavelength of 9.5 μm of 25%, 30%, 35%, 40%, 45%, 50%, 55%, 60%, 65%, 70%, 75%, 80%, 85%, 90%, 95%, up to 99%, or between any two of the above numbers.

In some embodiments, the fibrous insulation of the insulation layer 504 includes a fibrous wadding (sheet insulation) and/or loose insulation (synthetic down). In some embodiments, the fibrous insulation of the insulation layer 504 is provided at a low density to maximizing the warming effect through the reflective metallized sheet 502. For example, for apparels, the fibrous insultation may have a density of about 15, 20, 25, 30, 35, 40, 45, 50, 60, 70, 80, 90, or 100 g/m² (gsm), or between any two of the above numbers. For use in a sleep bag, the fibrous insultation may have a density of about 200 gsm. In some embodiments, a thickness of the insulation layer 504 is about 2 mm, 1 mm, 0.5 mm, or 0.1 mm.

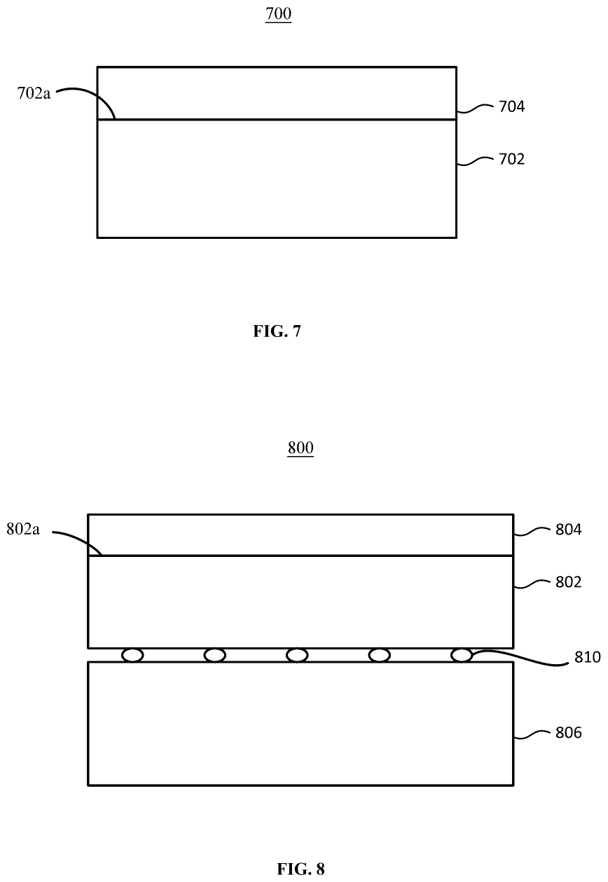

In some embodiments, the metallized sheet 502 includes a base layer containing a polymer and a metal layer deposited on the base layer, as will be explained in detail in connection with FIGS. 7-10.

In some embodiments, the metallized sheet 502 and the insulation layer 504 may be bonded together by a medium. For example, the metallized sheet 502 and the insulation layer 504 may be bonded by an adhesive. To provide reflective effect for the textile 500, in some embodiments, the adhesive may include an IR-transparent material. For example, The adhesive may include polyethylene. In some embodiments, the adhesive may be applied between the metallized sheet 502 and the insulation layer 504 as point contacts.

In some embodiments, the metallized sheet 502 and the insulation layer 504 may be sewed together.

FIG. 6 is a schematic diagram depicting a textile 600 according to one example embodiment. The textile 600 includes a metallized sheet 602, an insulation layer 604 disposed on the metallized sheet 602, and a cover layer 606 disposed on the insulation layer 604. The insulation layer 604 includes a fibrous insulation and has an IR transmittance of at least 35% at a wavelength of 9.5 μm. The metallized sheet 602 and the insulation layer 604 are similar to the metallized sheet 502 and the insulation layer 504 of the textile 500 illustrated in FIG. 5. The details of the metallized sheet 602 and the insulation layer 604 can be referred to above in connection with the description for the metallized sheet 502 and the insulation layer 504.

The cover layer 606 may be a lining layer to provide soft touch to the human skin. The cover layer 606 is configured to add high breathability to the textile 600 to make apparels and footwears that are made therefrom more comfortable to wear. In some embodiments, the lining layer 502 has a moisture vapor transmission rate of at least 500 g/m²/24 hr, at least 750 g/m²/24 hr, at least 1000 g/m²/24 hr, or at least 1500 g/m²/24 hr. In some embodiments, the cover layer 606 has a thickness of at least 60 micrometers to endure the wear and tear during its useful life time. Depending on where the textile 600 is applied to, the thickness of the cover layer 606 may vary. For example, the thickness of the cover layer 606 may be from about 60 micrometers to about 2400 micrometers, from about 60 micrometers to about 1500 micrometers, from about 60 micrometers to about 1000 micrometers, from about 60 micrometers to about 750 micrometers, or from about 60 micrometers to about 500 micrometers.

In some embodiments, the cover layer 606 includes one of a woven fabric, a knit fabric, or a non-woven fabric. In some embodiments, the cover layer 606 includes a synthetic material or a natural material. For example, the synthetic material for the cover layer 606 is selected from a group of polyester, polyamide, polyurethane, polyolefin, polylactic acid, and rayon. Further, the natural material for the cover layer 606 may include cotton, wool, silk, and other natural materials. In some embodiments, the cover layer 606 may be a metallized layer similar to or same as the metallized sheet 602. Depending on the use case, either the cover layer 606 or the metallized sheet 602 may be placed next to the skin.

Reference is now made to FIGS. 7-10 for details of a metallized sheet, such as the metallized sheet 502 or 602. FIG. 7 is a schematic diagram depicting a metallized sheet 700 according to one example embodiment. The metallized sheet 700 includes a base layer 702 and a metal layer 704 deposited on a first surface 702a of the base layer 702. For example, the metal layer 704 may be formed by vapor deposition of a metal onto the first surface 702a of the base layer 702.

The metallized sheet 700 is provided as a breathable radiant barrier for insulation purposes. For those purposes, the metallized sheet 700 is configured to have low emissivity and high breathability. In some cases, the metallized sheet 700 is water proof. In some embodiments, the base layer 702 of the metallized sheet 700 includes a polymer. To be effective for its purposes, the base layer 702 has a thickness less than about 500 micrometers, or less than 250 micrometers, or less than about 200 micrometers, or less than about 150 micrometers, or less than about 100 micrometers, or about 20-100 micrometers, or about 40-90 micrometers, or down to 10 micrometers or 5 micrometers. In some embodiments, the base layer 702 has an IR transparency of at least about 35% at a wavelength of 9.5 micrometers. In some embodiments, the base layer 702 has an IR transparency of about 40%, 50%, 60%, 70%, 80%, 90%, or between any two of the above numbers, at wavelength of 7-14 micrometers.

The base layer 702 has a first surface 702a in contact with the metal layer 704. The first surface 702a of the base layer 702 has a specular gloss of at least 28 percent (or at least about 15%, 20%, 25%, 30%, 35%, 40%, 45%, 50% or above, or between any two of the above numbers) to allow the base layer 702 to be more effective in reflecting thermal radiation.

The first surface 702a of the base layer 702 is configured to be flat, which results in a more effective reflection layer after the base layer 702 is metallized. In some embodiments, the base layer 702 includes polyethylene, which has a lower melting point than many conventional textile materials so that it can achieve flatter surface through calendaring at a lower temperature. In some embodiments, the base layer 702 may include one or more other materials, such as polyurethane, polyolefin, polyester, polyamide, cotton, wool, etc. The structure of the base layer 702 is configured to maximize the thermal radiation to be reflected back to the body because minimal heat is consumed to warm up the base layer 702 due to absorption.

The metal layer 704 may be formed on the base layer 702 by vapor deposition or other plating techniques. In some embodiments, the metal layer 704 may include one or more of aluminum, titanium, gold, copper, zinc, and silver etc. In some embodiments, the metal layer 704 may have a thickness of about 10 nanometers to about 200 nanometers, about 10 nanometers to about 100 nanometers, or about 10 nanometers to about 50 nanometers. Other metals and thickness are contemplated so that the metal layer 704 has an emissivity of no more than 0.5 for infrared radiation at a wavelength of 9.5 micrometers.

FIG. 8 is a schematic diagram depicting a metallized sheet 800 according to one example embodiment. The metallized sheet 800 includes a base layer 802, a metal layer 804 disposed on a first surface 802a of the base layer 802, and a lining layer 806. The base layer 802 and the metal layer 804 are similar to the base layer 702 and the metal layer 704 of the metallized sheet 700 illustrated in FIG. 7. The lining layer 806 and the base layer 802 are connected to each other via point contacts 810.

The lining layer 806 is configured to add high breathability. In some embodiments, the lining layer 806 has a moisture vapor transmission rate of at least 500 g/m²/24 hr, at least 750 g/m²/24 hr, at least 1000 g/m²/24 hr, or at least 1500 g/m²/24 hr. In some embodiments, the lining layer 806 has a thickness of at least 60 micrometers to endure the wear and tear during its useful life time. The thickness of the lining layer 806 may vary. For example, the thickness of the lining layer 806 may be from about 60 micrometers to about 2400 micrometers, from about 60 micrometers to about 1500 micrometers, from about 60 micrometers to about 1000 micrometers, from about 60 micrometers to about 750 micrometers, or from about 60 micrometers to about 500 micrometers.

In some embodiments, the lining layer 806 includes one of a woven fabric, a knit fabric, or a non-woven fabric. In some embodiments, the lining layer 806 includes a synthetic material or a natural material. For example, the synthetic material for the lining layer 806 is selected from a group consisting of polyester, polyamide, polyurethane, polyolefin, polylactic acid, and rayon. Further, the natural material for the lining layer 806 may include cotton, wool, silk, and other natural materials.

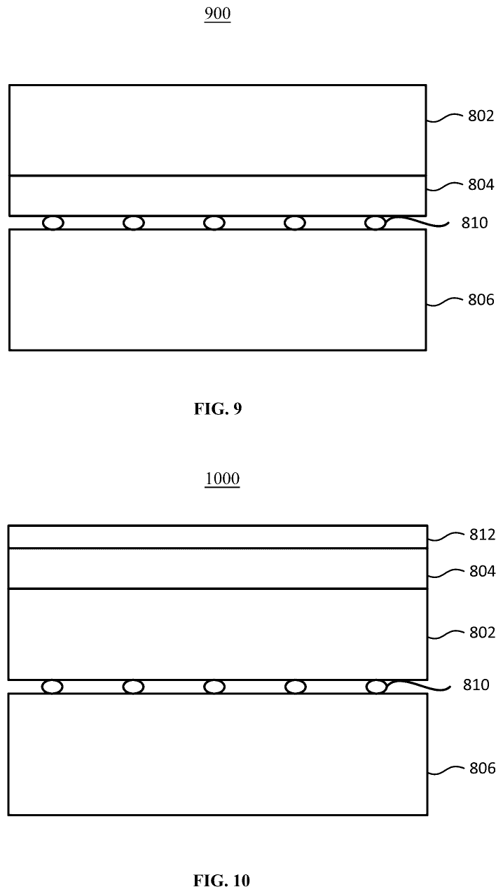

FIG. 9 is a schematic diagram depicting another metallized sheet 900 according to one example embodiment. The metallized sheet 900 is similar to the metallized sheet 800 with a modification where the metal layer 804 is sandwiched between the lining layer 806 and the base layer 802. The structure of the metallized sheet 800 can better protect the metal layer 804 from scratches or other accidental damages during the subsequent processing and use.

FIG. 10 is a schematic diagram depicting another metallized sheet 1000 according to one example embodiment. The metallized sheet 1000 is similar to the metallized sheet 800 with a modification where a protective layer 812 is disposed on the metal layer 804. The protective layer 812 may protect the metal layer 804 from being damaged. The protective layer 812 may include one or more organic materials and has a thickness of about 0.02 micrometers to about 2.5 micrometers.

In summary, in one aspect, a full PE textile disclosed herein has great instant cooling touch, which allows a user wearing the textile to feel cool. In addition, the disclosed full PE textile has high breathability, which makes it more comfortable to be worn than garment made from traditional textiles.

In another aspect, the full PE textile product disclosed herein are easily recyclable as they are made of a single material.

In another aspect, the disclosed techniques provide a textile with an IR transparent insulation layer and a metallized sheet, where the metallized sheet is configured to reflect thermal radiation emitted from human body and the IR transparent insulation layer is configured to reduce absorption of the thermal radiation to increase reflection of the radiation.

In another aspect, a cover layer may be provided to the textile such that the insulation layer is sandwiched between the metallized sheet and the cover layer.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A textile product comprising:
a first piece of fabric consisting of polyethylene (PE); and
a second piece of fabric consisting of PE,
wherein the first piece of fabric and the second piece of fabric are connected by a medium consisting of PE.

2. The textile of claim 1, wherein the medium is a PE sewing thread.

3. The textile of claim 2, wherein the PE sewing thread is 300 denier with a tenacity of 3.93 cN/dtex and elongation of 15%.

4. The textile of claim 2, wherein the PE sewing thread is 150 denier with tenacity of 2.0 cN/dtex and elongation of 32%.

5. The textile of claim 1, wherein the medium is a PE adhesive.

6. The textile of claim 1, wherein the medium is a melt of the first piece of fabric and the second piece of fabric.

7. The textile of claim 6, wherein the melt of the first piece of fabric and the second piece of fabric is produced by performing an ultrasonic welding, an infrared welding, or an induction welding on the first piece of fabric and the second piece of fabric.

8. The textile of claim 1, wherein the first piece of fabric is consisted of one or more first PE yarns.

9. The textile of claim 8, wherein the second piece of fabric is consisted of one or more second PE yarns.

10. The textile of claim 9, wherein the medium is a PE adhesive, and a melting temperature of the PE adhesive is lower than a melting temperature of the one or more first PE yarns or a melting temperature of the one or more second PE yarns.

11. A textile product comprising:
a metallized sheet; and
an insulation layer disposed on the metallized sheet,
wherein the insulation layer includes a fibrous insulation and has an infrared (IR) transmittance of at least 20% at a wavelength of 9.5 μm.

12. The textile product of claim 11, wherein the insulation layer has an IR transmittance of at least 40% at a wavelength of 9.5 μm.

13. The textile product of claim 11, wherein the insulation layer has an IR transmittance of at least 50% at a wavelength of 9.5 μm.

14. The textile product of claim 11, wherein the insulation layer has an IR transmittance of at least 70% at a wavelength of 9.5 μm.

15. The textile product of claim 11, wherein the insulation layer has an IR transmittance of at least 90% at a wavelength of 9.5 μm.

16. The textile product of claim 11, wherein the fibrous insulation of the insulation layer comprises fibers of one or more of polyethylene, polypropylene, and nylon.

17. The textile product of claim 16, wherein the fibrous insulation of the insulation layer further comprises polyester.

18. The textile product of claim 11, wherein the metallized sheet includes a base layer containing a polymer and a metal layer deposited on the base layer.

19. The textile product of claim 11, wherein the fibrous insulation of the insulation layer consists of polyethylene fibers.

20. A textile product comprising:
a metallized sheet;
an insulation layer disposed on the metallized sheet; and
a cover layer disposed on the insulation layer,
wherein the insulation layer includes a fibrous insulation and has an infrared (IR) transmittance of at least 20% at a wavelength of 9.5 μm.
